(19) United States
(12) Patent Application Publication
(10) Pub. No.: US 2014/0043393 A1
(43) Pub. Date: Feb. 13, 2014

(54) IMAGE FORMING METHOD

(71) Applicant: Noriyasu TAKEUCHI, Kanagawa (JP)

(72) Inventor: Noriyasu TAKEUCHI, Kanagawa (JP)

(21) Appl. No.: 13/936,444

(22) Filed: Jul. 8, 2013

(30) Foreign Application Priority Data
Aug. 9, 2012 (JP) 2012-177292

(51) Int. Cl. B41J 2/07

(52) U.S. Cl. CPC B41J 2/07
USPC 347/21

(57) ABSTRACT

An image forming method is provided. The image forming method includes applying a pretreatment liquid, which includes water, an organic solvent, and an agglomerating agent to agglomerate a colorant included in an ink, on a surface of a recording medium; and ejecting the ink, which includes the colorant, and water, to form an image on the surface of the recording medium on which the pretreatment liquid has been applied, wherein the pretreatment liquid applying step includes changing the application amount of the pretreatment liquid depending on the time period between application of the pretreatment liquid and ejection of the ink.

### CROSS-REFERENCE TO RELATED APPLICATIONS

This patent application is based on and claims priority pursuant to 35 U.S.C. §119 to Japanese Patent Application No. 2012-177292, filed on Aug. 9, 2012, in the Japan Patent Office, the entire disclosure of which is hereby incorporated by reference herein.

### TECHNICAL FIELD

The present invention relates to an image forming method using inkjet printing.

### BACKGROUND

Inkjet printing is a technology such that an ink is ejected as droplets from micro-nozzles according to image information using an on-demand pressurization method, a charge control method or the like, so that the droplets of the ink adhere to a recording medium such as paper sheets. The inkjet printing technology has been used for image forming apparatuses such as printers, facsimiles and copiers. In inkjet printing, an ink image can be formed by directly adhering an ink on a recording medium, and therefore printing can be performed by an apparatus having a simpler structure than indirect image forming apparatuses such as electrophotographic image forming apparatuses. Therefore, inkjet printing is considered to further develop in the future as an image forming method for forming images on a recording medium.

Inkjet printing is a low-noise printing method, and a direct ejection type inkjet printing method including ejecting an ink according to image signals to directly adhere the ejected ink droplets to a recording medium such as papers, cloths and plastic sheets is the mainstream of the inkjet printing methods. In addition, since inkjet printing does not use a plate when performing printing, a small number of prints can be produced efficiently, and therefore inkjet printing is expected to be used for industrial applications. In order that inkjet printing is used for industrial applications, images have to be printed on various kinds of recording media. However, the direct ejection type inkjet printing method, which is the mainstream of inkjet printing at the present time, is not satisfactory on this point. Namely, the direct ejection type inkjet printing method is an image forming method with many restrictions on the recording medium.

One of the restrictions concerns ink permeability of the recording medium.

Specifically, since almost all the components of inkjet ink are liquids, reproducibility of images is largely influenced by the ink absorption/permeability of the recording medium used. Particularly, when a recording medium into which ink hardly penetrates is used, a bleeding problem in that ink droplets, which are formed on the recording medium so as to be adjacent to each other, are mixed with each other, and a beading problem in that a first ink droplet deposited on a recording medium is attracted by a second ink droplet deposited on the recording medium after the first ink droplet tend to be easily caused, thereby deteriorating the image quality. In contrast, when a recording medium such as plain papers (non-coat papers) into which ink easily penetrates is used, a feathering problem in that the edge of an ink dot image blurs due to excessive penetration of the ink into the recording medium, and other problems such that different color ink dot images are mixed at the interface therebetween; and the colorant included in the ink penetrates into the recording medium without remaining on the surface of the recording medium, resulting in decrease of the image density are caused.

In addition, when a line inkjet printing head, which extends in the width direction of the recording medium, is used to increase the recording speed, adjacent ink droplets are deposited on the recording medium at substantially the same time, and therefore the above-mentioned problems concerning interference between adjacent ink dots are easily caused.

In attempting to solve the problems, a technique in that a pretreatment liquid having an effect to agglomerate a colorant of an ink is previously applied on a recording medium, and then droplets of the ink are ejected so that the colorant in the ink droplets on the recording medium is agglomerated by the pretreatment liquid (i.e., the viscosity of the ink is increased), thereby preventing interference between adjacent ink droplets, resulting in formation of images without defects such as uneven density image.

On the other hand, recently digital printing apparatuses such as inkjet printing apparatuses have been used for the printing field. However, coated papers used for printing such as offset printing has a poor liquid absorbing property to obtain good printing property. Therefore, the above-mentioned problems concerning interference between adjacent ink droplets are easily caused when the coated papers are used for inkjet printing. This is a big problem to be solved.

In attempting to solve the problem, techniques of using such a pretreatment liquid as mentioned above, which has a function of agglomerating a colorant included in an ink, have been developed. By using the techniques, the problems concerning interference between adjacent ink droplets can be solved, but another problem in that the drying property of prints deteriorates is caused. Specifically, such a pretreatment liquid typically includes a water-soluble solvent having a high boiling point to enhance the preservation stability thereof. Since this solvent remains in the recording medium without being evaporated, the drying property of prints deteriorates. Therefore it is preferable that the application amount of such a pretreatment liquid is as small as possible.

In attempting to decrease the application amount of a pretreatment liquid, JP-2010-120337-A discloses a technique in that the ink ejection amount is adjusted depending on the penetration amount of the pretreatment liquid previously applied on a recording medium is proposed. In addition, JP-2008-006734-A discloses a technique in that the distance between a pretreatment liquid applicator to a recording head is changed depending on the feeding speed of a recording medium is proposed.

### SUMMARY

As an aspect of the present invention, an image forming method is provided which includes a pretreatment liquid application process of applying a pretreatment liquid, which includes water, an organic solvent, and an agglomerating agent to agglomerate a colorant included in an ink, on a surface of a recording medium; and an ink ejecting process of ejecting the ink, which includes the colorant, and water, to form an image on the surface of the recording medium on which the pretreatment liquid has been applied. In this image forming method, the pretreatment liquid applying step includes changing an application amount of the pretreatment liquid depending on the time period between application of the pretreatment liquid and ejection of the ink.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a schematic view illustrating an image forming apparatus for use in the image forming method according to an embodiment;

FIG. 2 is a schematic view illustrating relation between time elapsed (i.e., time period between application of a pretreatment liquid and ejection of an ink), and beading and the ratio of the pretreatment liquid remaining on a recording paper;

FIG. 3 is a schematic view illustrating another image forming apparatus for use in the image forming method;

FIG. 4 is a schematic view illustrating a roller-type pretreatment liquid applicator having a squeeze roller for use in the image forming apparatuses illustrated in FIGS. 1 and 3;

FIG. 5 is a schematic view illustrating another roller-type pretreatment liquid applicator having an anilox roller for use in the image forming apparatuses;

FIG. 6 is a schematic view illustrating relation between the roller speed ratio (ratio of the squeeze roller rotation speed to the recording medium feeding speed) and the application amount ratio (relative application amount) in the roller-type pretreatment liquid applicator illustrated in FIG. 4; and

FIG. 7 is a schematic view illustrating relation between the anilox roller/application roller speed ratio and the application amount ratio (relative application amount) in the roller-type pretreatment liquid applicator illustrated in FIG. 5.

### DETAILED DESCRIPTION

The inventors recognized that there is a need for an image forming method using inkjet printing which uses an ink and a pretreatment liquid having a function of agglomerating a colorant included in the ink, wherein the application amount of the pretreatment liquid is as small as possible.

The image forming method according to an embodiment is different in configuration from the conventional techniques mentioned above, and is the following image forming method (1).

(1) An image forming method including a pretreatment liquid application process of applying a pretreatment liquid, which includes water, an organic solvent, and an agglomerating agent to agglomerate a colorant included in an ink, on a surface of a recording medium; and an ink ejecting process of ejecting the ink, which includes the colorant, and water, to form an image on the surface of the recording medium on which the pretreatment liquid has been applied, wherein the application amount of the pretreatment liquid is changed depending on the time period between the pretreatment liquid application process and the ink ejection process.

Since the application amount is changed in this image forming method, the method is different from the above-mentioned conventional techniques.

The image forming method (1) can include the following embodiments (2) to (5).

(2) The image forming method described in paragraph (1), which is characterized in that as the time period between the pretreatment liquid application process and the ink ejection process shortens, the application amount of the pretreatment liquid is decreased.
(3) The image forming method described in paragraph (1) or (2), which is characterized by further including a heating process, which is performed between the pretreatment liquid application process and the ink ejection process, wherein the application amount of the pretreatment liquid is changed depending on whether or not the heating process is performed.
(4) The image forming method described in any one of paragraphs (1) to (3), which is characterized in that the pretreatment liquid application process is performed using a pretreatment liquid applicator using an application amount measuring device to measure the pretreatment liquid, and a first roller (a pretreatment liquid applying member) to apply the measured pretreatment liquid on the recording medium.
(5) The image forming method described in paragraph (4), which is characterized in that the application amount measuring device includes a second roller to pick up the pretreatment liquid to transfer the pretreatment liquid to the first roller, wherein the application amount of the pretreatment liquid is changed by changing the rotation speed of the second roller.

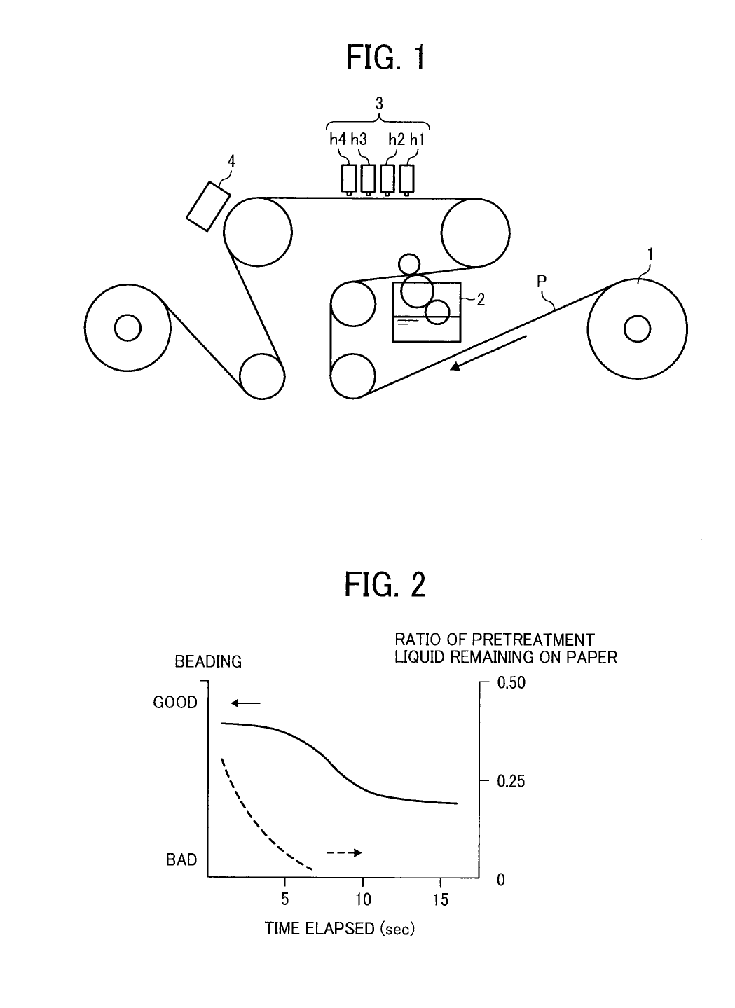

FIG. 1 illustrates an image forming apparatus for use in the image forming method according to an embodiment.

Referring to FIG. 1, a pretreatment liquid is applied on a surface of a recording medium P such as papers, which is fed from a sheet feeder 1, by a pretreatment liquid applicator 2, and then ink droplets are ejected by recording heads h1, h2, h3 and h4 of an ink ejecting device 3 toward the surface of the recording medium P, on which the pretreatment liquid has been applied. The recording medium P bearing the pretreatment liquid and the ink droplets thereon is then dried by a drier 4. Thus, ink images are formed on the surface of the recording medium P.

In a case where the application amount of the pretreatment liquid is constant, as the time period between the application of the pretreatment liquid and the ink ejection lengthens, the amount of the pretreatment liquid remaining on a paper (serving as the recording medium P) decreases as illustrated by a broken line in FIG. 2. In addition, the pretreatment liquid gradually penetrates into the paper P after being applied to the paper.

In contrast, as illustrated by a solid line in FIG. 2, the beading preventing effect of the pretreatment liquid deteriorates with time. Particularly, the beading preventing effect largely changes at a time in which the entire pretreatment liquid is absorbed by the paper P and there is no residual pretreatment liquid on the surface of the paper.

Therefore, it can be easily understood form these results that when the pretreatment liquid is present on the surface of the paper, good beading preventing effect can be produced.

The reason therefor is considered as follows. Specifically, when ink droplets ejected form the ink ejecting device 3 are contacted with the pretreatment liquid, the colorant included in the ink droplets is agglomerated, and thereby the viscosity of the ink droplets is increased. Therefore, when the pretreatment liquid remains on the surface of the paper P, agglomeration of the colorant can be caused right after the ink droplets are adhered to the surface of the paper. However, when the pretreatment liquid penetrates into the paper P and does not remain on the surface of the paper, agglomeration of the colorant is not started before the ink droplets penetrate into an inner portion of the paper in which the pretreatment liquid is present. Therefore, it takes a relatively long time until agglomeration of the colorant, and thereby the agglomerating effect is deteriorated. In other words, when ink droplets are ejected right before the pretreatment liquid is completely absorbed by the paper, images having desired image qualities can be obtained in a minimum amount of the pretreatment liquid.

The time period between application of the pretreatment liquid and ejection of the ink is determined based on the distance between the pretreatment liquid applicator 2 and the ink ejecting device 3, and the feeding speed of the paper P. For example, as the feeding speed of the paper P increases (decreases), the time period between application of the pretreatment liquid and ejection of the ink shortens (lengthens). When the time period between application of the pretreatment liquid and ejection of the ink is changed while the application amount of the pretreatment liquid is the same, the effect of the pretreatment liquid weakens if the time period is long, because the pretreatment liquid penetrates into the recording medium. Therefore, it is preferable that the application amount of the pretreatment liquid is determined based on the case where the time period is long (maximum). However, in this case, when image formation is performed while the time period is relatively short, the amount of the pretreatment liquid on the surface of the recording medium is too large (i.e., the pretreatment liquid is wastefully used), resulting in increase of costs. In addition, the pretreatment liquid typically includes a water-soluble solvent having a high boiling point to enhance the preservation stability thereof. Since the drying property of ink images changes depending on the amount of such a water-soluble solvent, the application amount of the pretreatment liquid is preferably as small as possible, i.e., application of an excessive amount of the pretreatment liquid is a problem to the drying property of ink images. Particularly, when the paper feeding speed is relatively fast, and the time period between application of the pretreatment liquid and ejection of the ink is relatively short, application of an excessive amount of the pretreatment liquid is a burden on the drying process because the applied pretreatment liquid has to be dried rapidly.

In the image forming method according to an embodiment, when the time period between application of the pretreatment liquid and ejection of the ink changes, the application amount of the pretreatment liquid is changed depending on the time period. Specifically, the image forming method performs control such that as the time period between application of the pretreatment liquid and ejection of the ink lengthens, the application amount of the pretreatment liquid increases. By using this method, application of an excessive amount of the pretreatment liquid can be prevented.

When the application amount of the pretreatment liquid is increased, the application amount is preferably from 1.0 to 3.0 times, and more preferably from 1.0 to 2.5 times, the minimum amount of the pretreatment liquid, i.e., the amount for a case where the ink is ejected right after the pretreatment liquid is applied. By controlling the application amount in this range, the effect of the pretreatment liquid can be well produced even when the time period between application of the pretreatment liquid and ejection of the ink is relatively long and a heating process is optionally performed, thereby making it possible to prevent formation of uneven images. When a drying process is performed, the penetrated portion of the pretreatment liquid is dried (lost) regardless of the time period, and therefore it has no effect to further increase the application amount of the pretreatment liquid.

The feeding speed of the recording medium P is typically changed depending on the resolution of the image to be printed such that when a high-resolution image is formed, the feeding speed of the recording medium is decreased. This is because the frequency of ink droplet ejection has a maximum value, which depends on the property of the recording head used, and therefore when a high-resolution image is recorded, the recording speed is limited.

In order to maximize the productivity in a case where the frequency of ink droplet ejection is limited, for example, if a line inkjet printhead is used, the recording speed at a resolution of 1,200 dpi (dot per inch, i.e., dots/25.4 mm) has to be reduced to one half of the recording speed at a resolution of 600 dpi, and in addition the feeding speed of the recording medium has to be also reduced to one half. In this case, the time period between application of the pretreatment liquid and ejection of the ink changes, and therefore the application amount of the pretreatment liquid is adjusted. In this example, since the feeding speed of the recording medium in the 600 dpi printing is faster than in the 1,200 dpi printing, the application amount of the pretreatment liquid in the 600 dpi printing is smaller than in the 1,200 dpi printing.

When a serial recording head, which records an image while moving in the width direction of the recording medium, is used, the feeding speed of the recording medium is changed depending on the resolution of images to be printed, and therefore the time period between application of the pretreatment liquid and ejection of the ink changes.

In this example, changing of the feeding speed of a recording medium is described by reference to an example in which the resolution of images to be printed is changed, but is not limited thereto. For example, the feeding speed of a recording medium is often changed due to increase in productivity or other reasons.

In addition, the time period between application of the pretreatment liquid and ejection of the ink changes when recording conditions are changed. For example, when the image forming apparatus has plural sheet feeding passages, and/or plural ink ejecting portions in a sheet feeding passage, the time period between application of the pretreatment liquid and ejection of the ink changes depending on the selected sheet feeding passage and/or the selected ink ejecting portion.

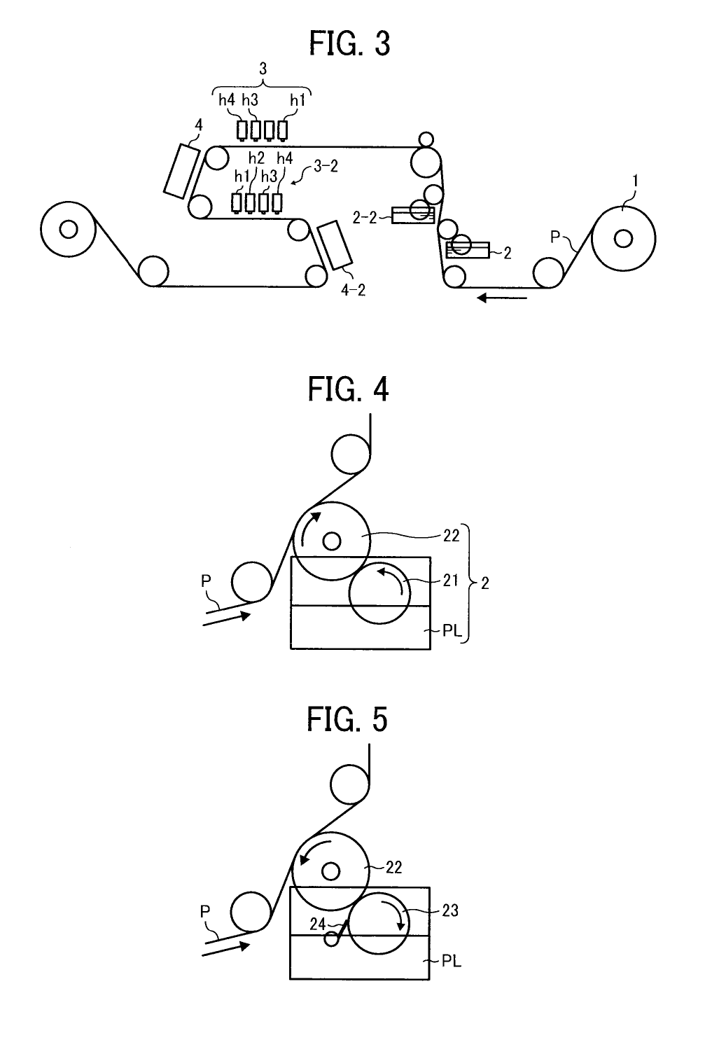

FIG. 3 illustrates an example of such an image forming apparatus. Referring to FIG. 3, the first and second surfaces of the recording medium P are applied with the pretreatment liquid by the pretreatment liquid applicators 2 and 2-2, respectively, and then inks are ejected toward the first surface by a first ink ejecting device 3, followed by ink ejection by a second ink ejecting device 3-2 toward the second surface of the recording medium P. It is clear from FIG. 3 that the distance between the pretreatment liquid applicator 2 to the ink ejecting device 3 is different for the first surface and the second surface of the recording medium P. In addition, the direction of the sheet feeding passage is reversed between the first ink ejecting device 3 and the second inkjet ejecting device 3-2. Further, the drier 4 is provided between the first ink ejecting device 3 and the second inkjet ejecting device 3-2 to dry the ink on the first surface of the recording medium P. Therefore, there is a considerable distance between the first ink ejecting device 3 and the second ink ejecting device 3-2. It is possible to separate the second pretreatment liquid applicator 2-2 from the first pretreatment liquid applicator 2 by the same distance as the distance between the first and second ink ejecting devices. However, in this case, the sheet feeding passage excessively lengthens, resulting in enlargement of the image forming apparatus.

Further, in the image forming apparatus illustrated in FIG. 3, after the pretreatment liquid is applied, the first printing, the first drying, the second printing and the second drying are performed. When the first drying is performed by heating, penetration of the pretreatment liquid applied to the second surface of the recording medium P is accelerated by the first drying (heating). Therefore, the degree of penetration of the pretreatment liquid is different form that in a case where drying (heating) is not performed (i.e., even when the time period between application of the pretreatment liquid and ejection of the ink is the same, the degree of penetration of the pretreatment liquid is different). Therefore, the application amount of the pretreatment liquid has to be adjusted when the pretreatment liquid is applied to the second surface of the recording medium P. Specifically, when performing drying (heating), the application amount of the pretreatment liquid is adjusted so as to be larger than in a case where drying (heating) is not performed.

For example, when an image is formed on the second surface of the recording medium P, the application amount of the pretreatment liquid is changed depending on whether or not an image is to be formed on the first surface. Specifically, in a case where an image is to be formed on the first surface of the recording medium, after an image is formed on the first surface, followed by drying, an image is formed on the second surface of the recording medium. In contrast, in a case where an image is not to be formed on the first surface of the recording medium, an image is formed on the second surface without performing the drying process of drying the first surface before the image formation. When the drying process is performed by heating, penetration of the pretreatment liquid, which is applied to the second surface, into the recording medium is accelerated. Therefore, if the application amount of the pretreatment liquid is the same, the effect of the pretreatment liquid weakens in this case. Therefore, in a case where drying is performed before image formation, the application amount of the pretreatment liquid is increased so as to be larger than in a case where drying is not performed, so that the effect of the pretreatment liquid can be satisfactorily produced. In this example, even when the time period between application of the pretreatment liquid and ejection of the ink is the same, the application amount of the pretreatment liquid is changed depending on whether or not drying is performed by heating before image formation. By using this method, formation of defective images (such as formation of beading) due to insufficient application amount of the pretreatment liquid or excessive consumption of the pretreatment liquid can be prevented.

When applying the pretreatment liquid, a contact method using an applicator having a roller (illustrated in FIG. 1), a non-contact method such as liquid ejecting methods (like ink ejecting methods), or the like method can be used. When a liquid ejecting method is used, it is possible that the pretreatment liquid is not applied to a non-image portion, and therefore consumption of the pretreatment liquid can be reduced. However, the liquid ejecting method has a disadvantage such that the pretreatment liquid has restrictions on viscosity and surface tension. In contrast, the contact method using a roller-type applicator has an advantage such that the applicator is simple, but has a disadvantage such that the pretreatment liquid is applied on the entire surface of the recording medium, i.e., the pretreatment liquid is applied on a non-image portion.

When a liquid ejecting method is used, the pretreatment liquid is applied as discrete droplets. Therefore, in order to form an even layer of the pretreatment liquid, the pretreatment liquid has to spread along the surface of the recording medium. When the recording medium is a non-coated paper having no coat layer, the pretreatment liquid rapidly penetrates into the paper, and then the pretreatment liquid spreads in the direction parallel to the surface of the paper. Therefore, the pretreatment liquid can be evenly applied. In a coated paper used for offset printing, absorption of the pretreatment liquid is slower than in a non-coated paper. In this regard, when the pretreatment liquid is applied by the liquid ejecting method, the droplets of the pretreatment liquid remain on the surface of the coated paper without rapidly penetrating into the paper. However, similarly to the ink droplets mentioned above, the adjacent droplets of the pretreatment liquid interfere with each other, resulting in movement of the droplets, thereby forming an uneven pretreatment liquid layer on the coated paper. In contrast, when a contact method using a roller-type applicator is used, a thin layer of the pretreatment liquid is formed on the roller, and the thin layer is transferred onto the surface of the recording medium. Therefore, an even pretreatment liquid layer can be formed on the coated paper.

FIGS. 4 and 5 illustrate examples of the roller-type applicator for use as the pretreatment liquid applicator.

The applicator 2 illustrated in FIG. 4 has a simple structure such that an application roller 22, which serves as a pretreatment liquid applying member to apply a pretreatment liquid PL to the recording medium P, is contacted, at a proper pressure, with a squeeze roller 21, which serves as a pretreatment liquid measuring member to pick up the pretreatment liquid PL to apply the pretreatment liquid to the application roller while measuring the pretreatment liquid. In this applicator, the amount of the pretreatment liquid PL passing through the nip between the application roller 22 and the squeeze roller 21 is controlled, and the pretreatment liquid layer thus formed on the application roller 22 is transferred onto the surface of the recording medium P. Although this applicator has a simple structure, the application amount of the pretreatment liquid changes depending on the viscosity of the pretreatment liquid and the feeding speed of the recording medium P, and therefore it is slightly hard to severely control the application amount.

In contrast, the applicator 2 illustrated in FIG. 5, which uses a gravure offset coating method, uses an anilox roller 23, which serves as the pretreatment liquid measuring member and on which grooves are formed with regularity, and a doctor blade 24, which serves as the pretreatment liquid measuring member and is contacted with the surface of the anilox roller 23. The grooves on the surface of the anilox roller 23 is filled with the pretreatment liquid by the doctor blade 24 (i.e., the volume of the pretreatment liquid on the anilox roller 23 is measured), and the pretreatment liquid in the grooves of the anilox roller is transferred onto the application roller 22, followed by transferring the pretreatment liquid to the recording medium P. Since this method has a measuring function, the pretreatment liquid can be evenly applied stably to the recording medium with hardly affected by the viscosity of the pretreatment liquid and the feeding speed of the recording medium.

Specifically, in the applicator illustrated in FIG. 4, the application amount of the pretreatment liquid changes depending on the variables such as rotation speed of the squeeze roller 21 and the application roller 22, viscosity of the pretreatment liquid, and pressure at the nip between the application roller 22 and the squeeze roller 21. In contrast, in the applicator 2 illustrated in FIG. 5, the amount of the pretreatment liquid on the surface of the anilox roller 23 is determined based on the volume of the grooves on the surface of the anilox roller, and therefore the application amount of the pretreatment liquid hardly changes even when the pressure at the nip between the application roller 22 and the anilox roller 23 changes. Therefore, the pretreatment liquid can be evenly applied stably to the recording medium P by the applicator 2.

In order to adjust the application amount of the pretreatment liquid using the applicator 2 illustrated in FIG. 4, the rotation speed of the squeeze roller 21 (the application roller 22) is preferably changed (the rotation speed of the squeeze roller is the same as that of the application roller in this applicator). Namely, the speed of the squeeze roller 21 relative to the feeding speed of the recording medium P is changed to adjust the application amount of the pretreatment liquid. When the relative speed of the squeeze roller 21 is lower than 1, the application amount of the pretreatment liquid decreases. In contrast, when the relative speed of the squeeze roller 21 is higher than 1, the application amount of the pretreatment liquid increases.

In the applicator illustrated in FIG. 5, by changing the anilox roller 23 with another anilox roller having grooves having a different volume, the application amount of the pretreatment liquid can be changed. However, this method has disadvantages such that several different anilox rollers have to be used while changed, and a complex mechanism has to be used for automatically adjusting the application amount.

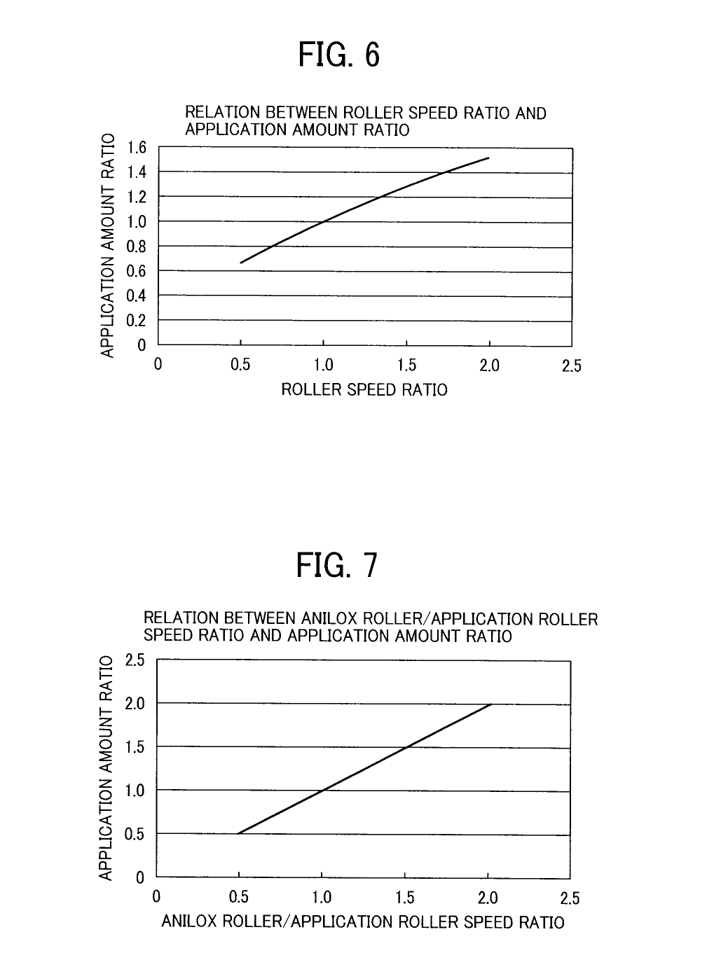

In the applicator 2 illustrated in FIG. 4, the application amount of the pretreatment liquid can be changed by changing the rotation speed of the squeeze roller 21. FIG. 6 illustrates relation between the roller speed ratio (i.e., the ratio of the squeeze roller speed to the recording medium feeding speed) and the application amount ratio (i.e., relative application amount). As illustrated in FIG. 6, as the rotation speed of the squeeze roller, which is the same as the roller speed of the application roller, decreases, the application amount decreases. In other words, as the rotation speed increases, the application amount increases. This is because the amount (thickness) of the pretreatment liquid passing through the nip between the squeeze roller 21 and the application roller 22 changes depending on the rotation speed of the squeeze roller 21.

In the applicator 2 illustrated in FIG. 5 using an anilox roller, the amount of the pretreatment liquid on the anilox roller is substantially constant independently of the rotation speed thereof, but the application amount of the pretreatment liquid changes depending on the ratio (rotation speed ratio) of the rotation speed of the anilox roller 23 to the rotation speed of the application roller 22. This is because the amount of the pretreatment liquid on the surface of the application roller 22 is changed as the anilox roller/application roller speed ratio is changed as illustrated in FIG. 7.

Next, the pretreatment liquid will be described in detail.

The pretreatment liquid for use in the image forming method includes an agglomerating agent to agglomerate a colorant included in an ink, an organic solvent, and water. In addition, other components such as surfactants, antibacterial agents, and antirusts can be optionally included in the pretreatment liquid.

Suitable materials for use as the agglomerating agent include water soluble materials which can form an ionic associate with an anionic group included in the colorant or a resin component included in a dispersant included in the ink by an ionic interaction, and for example, at least one of multivalent metal salts, polymers having a cationic group, and organic acids and their salts capable of acidifying water, can be preferably used.

Among multivalent metal salts, metal salts having a metal ion such as Ca²⁺, Mg²⁺, Sr²⁺, and Al³⁺, and an anion such as NO³⁻, and SO³⁻ are preferably used because of having a good combination of reactivity and handling property. Since organic acids are produced in a human body or are included in foods, organic acids do not remain (accumulate) in a human body and are typically odorless. Therefore, organic acids are preferably used for image forming apparatuses for home or office use. Specific examples thereof include succinic acid, citric acid, malic acid, tartaric acid, lactic acid, and salts of these acids.

Cationic compounds can also be used as the agglomerating agent, and, for example, polyamines can be used. Specific examples of such polyamines include dimethylamine, diethylamine, dipropylamine, methylethylamine, methylpropylamine, methylbutylamine, methyloctylamine, methyllaurylamine, ethylenediamine, diethylenetriamine, polyallylamine, polyethyleneimine, piperidine, pyrrole, and carbazole.

These agglomerating agents can be used alone or in combination.

The content of such an agglomerating agent in the pretreatment liquid is preferably from 1 to 40% by weight, more preferably from 5 to 30% by weight, and even more preferably from 10 to 25% by weight.

The pretreatment liquid preferably includes, as the organic solvent, a water soluble organic solvent having a high boiling point in an amount of from 8 to 25% by weight based on the weight of the pretreatment liquid. The boiling point of the water soluble organic solvent is preferably not lower than 150° C. Suitable solvents for use as such water soluble organic solvents include polyalcohols, polyalcohol derivatives, nitrogen-containing solvents, alcohols, and sulfur-containing solvents. These solvents can be used alone or in combination.

Specific examples of the polyalcohols include ethylene glycol, diethylene glycol, propylene glycol, butylene glycol, triethylene glycol, 1,5-pentanediol, 1,2,6-hexanetriol, and glycerin.

Specific examples of the polyalcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and ethylene oxide adducts of diglycerin.

Specific examples of the nitrogen-containing solvents include pyrrolidone, N-methyl-2-pyrrolidone, cyclohexyl pyrrolidone, and triethanolamine.

Specific examples of the alcohols include ethanol, isopropyl alcohol, butyl alcohol, and benzyl alcohol.

Specific examples of the sulfur-containing solvents include thiodiethanol, thiodiglycerol, sulfolane, and dimethylsulfoxide.

Other solvents such as propylene carbonate, and ethylene carbonate can also be used as the organic solvent.

A surfactant is included in the pretreatment liquid so that the pretreatment liquid spreads evenly on the surface of a recording medium. Among various surfactants, surfactants having both a hydrophilic portion and a hydrophobic portion in a molecule thereof are preferable, and any anionic, cationic, ampholytic and nonionic surfactants can be used. The content of a surfactant in the pretreatment liquid is preferably from 0.01 to 5% by weight.

The application amount of the pretreatment liquid is not particularly limited as long as the applied pretreatment liquid can heighten the viscosity of ink droplets adhered thereto, and is preferably not less than 0.5 g/m². In order to easily agglomerate an aqueous ink, the application amount is preferably 0.8 to 2.0 g/m², and more preferably from 1.0 to 1.5 g/m².

Next, the ink for use in the image forming method will be described.

The ink includes a colorant and water, and optionally includes an organic solvent. In addition, other components such as surfactants, penetrants, antibacterial agents, antirusts, pH controlling agents, ultraviolet absorbents, infrared absorbents, solid humectants, and water dispersible resins can be included in the ink.

Pigments and hydrophobic dyes can be used as the colorant. Hydrophobic dyes have good adsorptive property and encapsulating property, and pigments have good light resistance.

Specific examples of black pigments include carbon black. Specific examples of color pigments include anthraquinone compounds, Phthalocyanine Blue, Phthalocyanine Green, diazo compounds, monazo compounds, pyranthron compounds, perylene compounds, heterocyclic yellow pigments, quinacridone compounds, and thioindigo pigments. Specific examples of the Phthalocyanine Blue include copper Phthalocyanine Blue, and derivatives thereof (such as Pigment Blue 15). Specific examples of the quinacridone compounds include Pigment Oranges 48 and 49, Pigment Reds 122, 192, 202, 206, 207 and 209, and Pigment Violets 19 and 42. Specific examples of the anthraquinone compounds include Pigment Reds 43, 194 (perynone red), 216 (brominated pyranthron red), and 226 (pyranthron red). Specific examples of the perylene compounds include Pigment Reds 123 (vermilion), 149 (scarlet), 179 (maroon), 190 (red), 189 (yellow shade red), and 224, and Pigment Violet. Specific examples of the thioindigo pigments include Pigment Reds 86, 87, 88, 181 and 198, and Pigment Violets 36 and 38. Specific examples of the heterocyclic yellow pigments include Pigment Yellows 117 and 138. Other color pigments are exemplified in “The Colour Index, third edition” (The Society of Dyers and Colourists, 1982).

Pigments, whose surface is bonded with a hydrophilic group directly or via a group and which can be stably dispersed in the ink without a dispersant, can be used as the colorant. It is preferable for such pigments to have ionicity, and anionically or cationically-charged pigments are preferably used.

Specific examples of hydrophilic anionic groups bonded with such pigments include groups such as —COOM, —SO₃M, —PO₃HM, —PO₃M₂, —SO₂NH₂, and —SO₂NHCOR, wherein M represents a hydrogen atom, an alkali metal ion, an ammonium group, or an organic ammonium group, and R represents an alkyl group having 1 to 12 carbon atoms, a substituted or unsubstituted phenyl group, or a substituted or unsubstituted naphthyl group. Among these anionic hydrophilic groups, —COOM, and —SO₃M are preferable.

Specific examples of the method for preparing an anionically-charged pigment include a method in which a pigment is subjected to an oxidation treatment using sodium hypochlorite, a method in which a pigment is subjected to a sulfonation treatment, and a method in which a pigment is reacted with a diazonium salt, but are not limited thereto.

Specific examples of hydrophilic cationic groups bonded with such pigments include quaternary ammonium groups.

Aqueous pigment dispersions in which a pigment is dispersed in an aqueous medium using a dispersant can be used as the colorant of the ink. Suitable materials for use as the dispersant include known dispersants for use in preparing pigment dispersions.

Specific examples of such a dispersant include polyacrylic acid, polymethacrylic acid, acrylic acid-acrylonitrile copolymers, vinyl acetate-acrylate copolymers, acrylic acid-alkyl acrylate copolymers, styrene-acrylic acid copolymers, styrene-methacrylic acid copolymers, styrene-acrylic acid-alkyl acrylate copolymers, styrene-methacrylic acid-alkyl acrylate copolymers, styrene-α-methyl styrene-acrylic acid copolymers, styrene-α-methyl styrene-acrylic acid-alkyl acrylate copolymers, styrene-maleic acid copolymers, vinyl naphthalene-maleic acid copolymers, vinyl acetate-ethylene copolymers, vinyl acetate-fatty acid vinyl ester-ethylene copolymers, vinyl acetate-maleic acid ester copolymers, vinyl acetate-crotonic acid copolymers, and vinyl acetate-acrylic acid copolymers.

In addition, nonionic or anionic surfactants can be used as the dispersant depending on the choice of pigment and the formulation of the ink.

The added amount of such a surfactant type dispersant is preferably 10 to 50% by weight based on the weight of the pigment. When the added amount is less than 10% by weight, the preservation stability of the resultant pigment dispersion and ink tends to deteriorate, or it takes a long time to prepare a pigment dispersion. In contrast, when the added amount is greater than 50% by weight, the viscosity of the resultant ink tends to seriously increase, resulting in deterioration of the ejection stability of the ink.

Among nonionic surfactants, surfactants having a HLB of from 12 to 19.5, preferably from 13 to 19, are preferable. When the HLB is lower than 12, the affinity of the surfactant for a dispersing medium tends to deteriorate, resulting in deterioration of stability of the resultant pigment dispersion. When the HLB is higher than 19.5, the surfactant is not easily adsorbed on a pigment, resulting in deterioration of stability of the resultant pigment dispersion.

Specific examples of the nonionic surfactants include polyoxyethylene alkyl ethers such as polyoxyethylene lauryl ether, polyoxyethylene myristyl ether, polyoxyethylene cetyl ether, polyoxyethylene stearyl ether, and polyoxyethylene oleyl ether; polyoxyethylene alkylphenyl ethers such as polyoxyethylene octylphenyl ether and polyoxyethylene nonylphenyl ether; polyoxyethylene α-naphthyl ether, polyoxyethylene β-naphthyl ether, polyoxyethylene monostyrylphenyl ether, polyoxyethylene distyrylphenyl ether, polyoxyethylene alkylnaphthyl ethers, polyoxyethylene monostyrylnaphthyl ethers, polyoxyethylene distyrylnaphthyl ethers, and polyoxyethylene polyoxypropylene block copolymers. In addition, surfactants in which part of the polyoxyethylene group thereof is replaced with a polyoxypropylene group, and surfactants which are prepared by subjecting a compound having an aromatic ring such as polyoxyethylene alkylphenyl ethers to condensation using formalin can also be used.

Specific examples of the anionic surfactants include polyoxyethylene alkyl ether sulfuric acid salts, polyoxyethylene alkylphenyl ether sulfuric acid salts, polyoxyethylene monostyrylphenyl ether sulfuric acid salts, polyoxyethylene distyrylphenyl ether sulfuric acid salts, polyoxyethylene alkyl ether phosphoric acid salts, polyoxyethylene alkylphenyl ether phosphoric acid salts, polyoxyethylene monostyrylphenyl ether phosphoric acid salts, polyoxyethylene distyrylphenyl ether phosphoric acid salts, polyoxyethylene alkyl ether carboxylic acid salts, polyoxyethylene alkylphenyl ether carboxylic acid salts, polyoxyethylene monostyrylphenyl ether carboxylic acid salts, polyoxyethylene distyrylphenyl ether carboxylic acid salts, formalin condensation products of naphthalene sulfonic acid salts, formalin condensation products of melamine sulfonic acid salts, salts of dialkyl sulfosuccinate, di-salts of alkyl sulfosuccinate, di-salts of polyoxyethylene alkylsulfosuccinate, alkyl sulfoacetic acid salts, α-olefin sulfonic acid salts, alkylbenzene sulfonic acid salts, alkylnaphthalene sulfonic acid salts, alkylsulfonic acid salts, N-acylamino acid salts, acylated peptides, and soaps. Among these anionic surfactants, polyoxyethylen alkyl ethers, sulfates or phosphates of polyoxyethylen alkylphenyl ethers and polyoxyethylene distyrylphenyl ether are particularly preferable.

The above-mentioned hydrophobic dyes mean dyes which are insoluble or slightly soluble in water and which are soluble in organic solvents, and include oil-soluble dyes and disperse dyes. In this regard, water-insoluble or water-slightly-soluble dyes are defined as dyes which are soluble in water at a concentration of not greater than 0.1 parts by weight in 100 parts by weight of water. In addition, dissolving of a dye in a solvent means that the dye is not present as a particle on the surface or bottom of a liquid including the solvent and the dye by visual check.

Specific examples of the oil-soluble dyes include C.I. Solvent Blacks, C.I. Solvent Yellows, C.I. Solvent Reds, C.I. Solvent Violets, C.I. Solvent Blues, C.I. Solvent Greens, and C.I. Solvent Oranges. These dyes can be available from Orient Chemical Industries Co., Ltd.

Specific examples of the disperse dyes include C.I. Disperse Yellows, C.I. Disperse Oranges, C.I. Disperse Reds, C.I. Disperse Violets, C.I. Disperse Blues, and C.I. Disperse greens.

Among these dyes, C.I. Solvent Yellows 29 and 30 (yellow colorant), C.I. Solvent Blue 70 (cyan colorant), C.I. Solvent Reds 18 and 49 (magenta colorant), and C.I. Solvent Blacks 3 and 7, and nigrosine dyes (black colorant) are preferable.

Polymer emulsions in which a colorant included in a particulate polymer is dispersed can be used as the colorant of the ink. The above-mentioned hydrophobic dyes are typically used in this state.

In this regard, the state in which a colorant is included in a particulate polymer means a state in which a colorant is encapsulated in a particulate polymer and/or a state in which a colorant is adsorbed on a surface of a particulate polymer. In this regard, all of the colorant is not necessarily included in the particulate polymer or adsorbed on the particulate polymer, and part of the colorant may be dispersed in the resultant emulsion as long as the effect of the colorant is not deteriorated.

In order to effectively penetrate a colorant into a particulate polymer, the colorant is preferably dissolved in an organic solvent such as ketone solvents at a concentration of not less than 2 g/liter, and more preferably from 20 to 600 g/liter.

Suitable materials for use as the polymer of the above-mentioned polymer emulsion include vinyl polymers, polyester polymers, and polyurethane polymers. Among these polymers, vinyl polymers, and polyester polymers are preferable. Specific examples thereof include the polymers disclosed in JP-2000-53897-A, and JP-2001-139849-A.

The content of a colorant in the polymer emulsion is preferably from 10 to 200 parts by weight, and more preferably from 25 to 150 parts by weight, per 100 parts by weight of the polymer included in the polymer emulsion. The average particle diameter of the colorant-including polymer in the ink is preferably not greater than 0.16 μm.

The content of such a particulate polymer in the ink is preferably from 8 to 20% by weight, and more preferably from 8 to 12% by weight.

Specific examples of the organic solvent for use in the ink include polyalcohols such as ethylene glycol, diethylene glycol, triethylene glycol, propylene glycol, dipropylene glycol, tripropylene glycol, tetraethylene glycol, polyethylene glycol, polypropylene glycol, 1,3-butanediol, 2-methyl-1,3-butanediol, 3-methyl-1,3-butanediol, 2,3-butanediol, 1,4-butanediol, 1,5-pentanediol, 1,6-hexanediol, glycerol, 1,2,6-hexanetriol, 1,2,4-butanetriol, 1,2,3-butanetriol, 2-methyl-2,4-pentanediol, petriol, and 3-methoxy-3-methyl-1-butanediol; alkyl ethers of plyalcohols such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyalcohol aryl ethers such as ethylene glycol monophenyl ether, ethylene glycol monobenzyl ether, dipropylene glycol monobutyl ether, tripropylene glycol monobutyl ether, diethylene glycol isobutyl ether, triethylene glycol isobutyl ether, and diethylene glycol isopropyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylformamide, and N,N-dimethylformamide; amines such as monoethanolamine, diethanolamine, triethanolamine, monoethylamine, diethylamine, and triethylamine; sulfur-containing compounds such as dimethylsulfoxide, sulfolane, thiodiethanol, and thiodiglycol; and other solvents such as propylene carbonate and ethylene carbonate.

Among these organic solvents, glycerin, ethylene glycol, diethylene glycol, triethylene glycol, propylene glycol, dipropylene glycol, tripropylene glycol, 1,3-butanediol, 2-methyl-1,3-butanediol, 3-methyl-1,3-butanediol, 2,3-butanediol, 1,4-butanediol, 1,5-pentanediol, tetraethylene glycol, 1,6-hexanediol, 2-methyl-2,4-pentanediol, polyethylene glycol, 1,2,4-butanetriol, 1,2,6-hexanetriol, thiodiglycol, 2-pyrrolidone, N-methyl-2-pyrrolidone, N-hydroxyethyl-2-pyrrolidone, and 1,3-dimethyl-2-imidazolidinone are preferable because the solvents have good water solubility and can prevent occurrence of defective ejection caused by evaporation of water in the ink.

Fluorine-containing surfactants are preferably used as the surfactant to be included in the ink. Suitable materials for use as the fluorine-containing surfactant include perfluoroalkyl sulfonates, perfluoroalkyl carboxylates, perfluoroalkyl phosphates, perfluoroalkylethylene oxide adducts, perfluoroalkyl betaine, and perfluoroalkylamine oxide compounds. Specific examples of the marketed products of such fluorine-containing surfactant include SARFRONs S-111, S-112, S-113, S-121, S-131, S-132, S-141, and S-145 (from Asahi Glass Co., Ltd.); FLUORADs FC-93, FC-95, FC-98, FC-129, FC-135, FC-170C, FC-430, FC-431, and FC-4430 (from Sumitomo 3M Ltd.); MEGAFACEs F-470, F-1405, and F-474 (from DIC Corp.); ZONYLs FS-300, FSN, FSN-100 and FSO (from DuPont); and EFTOPs EF-351, 352, 801 and 802 (from Mitsubishi Materials Electronic Chemicals Co., Ltd.). Among these fluorine-containing surfactants, ZONYLs FS-300, FSN, FSN-100 and FSO are preferable because of having good reliability while producing images having good coloring property.

Specific examples of surfactants, which can be used in combination with the above-mentioned fluorine-containing surfactants, include polyoxyethylene alkyl ether acetates, dialkyl sulfosuccinates, polyoxyethylene alkyl ethers, polyoxyethylene alkylphenyl ethers, polyoxyethylene polyoxypropylene block copolymers, polyoxyethylene alkyl esters, polyoxyethylene sorbitan fatty acid esters, and acetylene glycol-based surfactants. In particular, when polyoxyethylene alkyl ether acetates and/or dialkyl sulfosuccinates having a branched alkyl group having 5 to 7 carbon atoms are used as an anionic surfactant, the resultant ink has good wettability for plain papers. The surfactants mentioned above are present stably in the ink without deteriorating the dispersion state.

Suitable materials for use as the penetrant include polyols having 7 to 11 carbon atoms, and specific examples thereof include 2-ethyl-1,3-hexanediol, and 2,2,4-trimethyl-1,3-pentanediol.

The added amount of such a penetrant is preferably form 0.1 to 20% by weight, and more preferably from 0.5 to 10% by weight, based on the weight of the ink. When the added amount is less than 0.1% by weight, the permeability of the ink into papers tends to deteriorate. Therefore, when the ink is used for high speed printing and/or duplex printing, problems such that ink images on a print are rubbed by a feeding roller of the printer, thereby contaminating the print; and ink images on a print are transferred onto a belt for reversing the print to produce a duplex print, thereby contaminating the print tend to be caused. In contrast, when the added amount is greater than 20% by weight, the diameter of an ink dot image increases, thereby causing a problem such that line images and character images broaden, thereby deteriorating definition of the images.

As the antibacterial agent, 1,2-benzisothiazoline-3-one is preferable. By using this compound, the ink has good reliability (i.e., a good combination of preservation stability and ejection stability) as well as a good antibacterial property. The added amount of such an antibacterial agent is preferably from 0.01 to 0.04 parts by weight based on the weight of the ink. When the added amount is less than 0.01 parts by weight, the antibacterial property of the ink is hardly enhanced. In contrast, when the added amount is greater than 0.04 parts by weight, problems such that when the ink is preserved for a long time (for example, for two years at room temperature, or for 1 to 3 months at 50 to 60° C.), particles (such as colorants) are agglomerated; and the viscosity of the ink is increased so as to be 1.5 to 2.0 times the initial viscosity tend to be caused, thereby making it impossible to maintain good image quality.

Specific examples of the antirust for use in the ink include acidic sulfites, sodium thiosulfate, ammonium thiodiglycolate, diisopropylammonium nitrite, pentaerythritol tetranitrate, and dicyclohexylammonium nitrite.

Any known materials can be used as the pH controlling agent as long as the materials can control the pH of the ink so as to be not lower than 7 without deteriorating the properties of the ink.

Specific examples thereof include amines such as diethanolamine and triethanolamine; alkali metal hydroxides such as lithium hydroxide, sodium hydroxide, and potassium hydroxide; hydroxides such as ammonium hydroxide, quaternary ammonium hydroxide, and quaternary phosphonium hydroxide; carbonates of alkali metals such as lithium carbonate, sodium carbonate, and potassium carbonate; and other materials such as aminopropanediol derivatives. Aminopropanediol derivatives are water-soluble organic basic compounds, and specific examples thereof include 1-amino-2,3-propanediol, 1-methylamino-2,3-propanediol, 2-amino-2-methyl-1,3-propanediol, and 2-amino-2-ethyl-1,3-propanediol. Among these compounds, 2-amino-2-ethyl-1,3-propanediol is preferable.

The solid humectant mentioned above is defined as a water-soluble compound which has a water retentivity and is a solid at room temperature (25° C.) and which is dissolved or partially dissolved in the ink without deteriorating the dispersion stability of the pigment in the ink (i.e., without agglomerating the pigment). Suitable materials for use as the solid humectant include saccharide.

Examples of saccharide include monosaccharide, disaccharide, oligosaccharide (including tri- and tetra-saccharide), and polysaccharide.

Specific examples thereof include glucose, mannose, fructose, ribose, xylose, arabinose, galactose, maltose, cellobiose, lactose, sucrose, trehalose, and maltotriose.

In this application, polysaccharide means saccharide in a broad sense, and includes materials present in nature such as α-cyclodextrin, and cellulose.

Not only the saccharide mentioned above but also derivatives thereof can be used. Specific examples of such derivatives include reduction materials of the saccharide mentioned above (e.g., sugar alcohols (having formula HOCH₂(CHOH)ₙCH₂OH, wherein n is an integer of from 1 to 6)), oxidation materials of the saccharide mentioned above (e.g., aldonic acid, and uronic acid), amino acids, and thio acids.

Among these materials, sugar alcohols are preferable. Specific examples of such sugar alcohols include maltitol, and sorbit.

As the water dispersible resin, urethane resin emulsions and silicone-modified acrylic resin emulsions are preferable. The water dispersible resin is present in the ink or a raw material of the ink in a form of 0/W emulsion. The content of the solid component of such an emulsion in the ink is preferably from 1 to 40% by weight, and more preferably from 1 to 20% by weight, based on the weight of the ink.

The volume average particle diameter of resin particles in the resin emulsion is preferably from 10 nm to 300 nm, and more preferably from 40 nm to 200 nm. When the volume average particle diameter is less than 10 nm, the viscosity of the resin emulsion seriously increases, thereby increasing the viscosity of the ink to an extent such that the ink is not be satisfactorily ejected from nozzles. In contrast, when the volume average particle diameter is greater than 300 nm, the nozzles tend to be clogged with the resin particles, thereby causing defective ink ejection, resulting in formation of defective images.

Polyurethane resin emulsions are broadly classified into emulsions in which a polyurethane resin having a relatively hydrophilic property is emulsified using an emulsifier; and self-emulsification type emulsions including a polyurethane resin, in which a functional group serving as an emulsifier is incorporated using a copolymerization method or the like so that the polyurethane resin can be self-emulsified. Among these emulsions, anionic self-emulsification type polyurethane emulsions have good dispersion stability. Among polyurethane resins, polyether polyurethane resins are superior to polyester polyurethane resins and polycarbonate polyurethane resins in fixability of a colorant to recording media and dispersion stability of the ink. The reason therefor is not yet determined, but is considered to be that non-ether type polyurethane resins typically have poor solvent resistance, and therefore the ink tends to easily cause agglomeration or viscosity increase when the ink is preserved at a high temperature.

The volume average particle diameter of polyether polyurethane resin emulsions is preferably not greater than 300 nm, more preferably not greater than 100 nm, and even more preferably not greater than 80 nm. When the volume average particle diameter is not greater than 100 nm, the ink can maintain good ejection stability even when the ink is allowed to settle in an inkjet printer for a long period of time.

The glass transition temperature of polyether polyurethane resin emulsions is preferably from −50 to 150° C., and more preferably from −10 to 100° C. When the glass transition temperature is higher than 150° C., the film of the polyurethane resin itself is hard but the film of the ink (i.e., a combination of a colorant and the polyurethane resin) is brittle and has poor abrasion resistance. The reason therefor is not yet determined. When the glass transition temperature is not higher than 150° C., the film of the ink has good abrasion resistance although the film of the polyurethane resin is soft like a rubber. In contrast, when the glass transition temperature is lower than −50° C., the film of the ink is too soft, and therefore the ink film has poor abrasion resistance. Therefore, when the added amount is constant, the glass transition temperature is preferably from −50 to 150° C. The glass transition temperature is measured by DSC (differential scanning calorimetry) or TMA (thermomechanical analysis).

The minimum film forming temperature (MFT) of polyether polyurethane resin emulsions for use in the ink is preferably not higher than room temperature, and more preferably not higher than 25° C. When the MFT is not higher than room temperature (preferably not higher than 25° C.), the ink image can be automatically bonded with fibers of recording papers even when the image is not heated or dried.

In this regard, the MFT of a polyether polyurethane resin emulsion can be determined by applying the emulsion diluted with water on a metal plate, and then naturally drying the emulsion to obtain a film of the polyether polyurethane resin. The film is observed to determine whether the film is transparent or opaque. This procedure is repeated while changing the environmental temperature to determine the MFT of the resin. The MFT is defined as the temperature, above which the film becomes transparent.

The above-mentioned silicone-modified acrylic resin can be prepared by polymerizing an acrylic monomer and a silane compound in the presence of an emulsifier.

Specific examples of the acrylic monomer include acrylate monomers such as methyl acrylate, ethyl acrylate, butyl acrylate, 2-ethylhexyl acrylate, 2-hydroxyethyl acrylate, acryloyl morpholine, and N,N′-dimethylaminoethyl acrylate; methacrylate monomers such as methyl methacrylate, ethyl methacrylate, butyl methacrylate, 2-ethylhexyl methacrylate, 2-hydroxyethyl methacrylate, and N,N′-dimethylaminoethyl methacrylate; amide acrylate monomers such as N-methylol acrylamide, and methoxymethyl acrylamide; and monomers having a group of carboxylic acid such as maleic acid, fumaric acid, and itaconic acid, acrylic acid, and methacrylic acid.

Specific examples of the emulsifier for use in preparing such silicone-modified acrylic resins include alkylbenzenesulfonic acids and salts thereof, dialkyl sulfosuccinates and salts thereof, dialkylnaphthalene sulfonic acids and salts thereof, formalin condensates of alkylnaphthalene sulfonates, higher fatty acids, sulfonates of higher fatty acid esters, polyoxypropylene-polyoxyethylene condensates of ethylene diamine, sorbitan fatty acid esters and salts thereof, aromatic or aliphatic phosphoric acid esters and salts thereof, dodecyl benzene sulfonic acid salts, dodecylsulfuric acid salts, laurylsulfuric acid salts, dialkylsulfosuccinic acid salts, polyoxyethylene alkylphenyl ether sulfuric acid salts, polyoxyethylene alkylpropenylphenyl ether sulfuric acid salts, alkyl phenyl ether disulfonic acid salts, polyoxyethylene alkyl phosphoric acid salts, polyoxyethylene alkylether acetic acid salts, polyoxyethylenelanolin alcohol ether, polyoxyethylenelanolin fatty acid esters, lauryl alcohol ethoxylate, lauryl ether sulfuric acid salts, lauryl ether phosphoric acid esters, sorbitan fatty acid esters, fatty acid diethanol amide, and formalin condensates of naphthalenesulfonic acid. The salts mentioned above are sodium salts, ammonium salts, etc.

Reactive emulsifiers having an unsaturated double bond can also be used as the emulsifier. Specific examples thereof include ADEKA REASORPs SE, NE and PP (from ADEKA CORP.); LATEMUL S-180 (from Kao Corp.); ELEMINOLs JS-2 and RS-30 (from Sanyo Chemical Industries, Ltd.); and AQUARON RN-20 (from Dai-Ichi Kogyo Seiyaku Co., Ltd.).

Specific examples of the silane compound include tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, hexyltrimethoxysilane, hexyltriethoxysilane, decyltrimethoxysilane, decyltriethoxysilane, and trifluoropropyltrimethoxysilane. In addition, monomers, which are used as silane coupling agents, can also be used.

Specific examples thereof include vinyltrichlorosilane, vinyltrimethoxysilane, vinyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, hydrochlorides of N-(vinylbenzyl)-2-aminoethyl-3-aminopropyltrimethoxysilane, 3-ureidopropyltriethoxysilane, 3-chloropropyltrimethoxysilane, bis(triethoxysilylpropyl)tetrasulfide, and 3-isocyanatepropyltriethoxysilane.

The MFT of the silicone-modified acrylic resins is preferably not higher than 20° C. When the MFT is higher than 20° C., the resultant ink image tends to have poor fixability. Specifically, when the ink image is rubbed or traced with a marker pen, the pigment in the ink image is released therefrom, thereby contaminating the print.

The amount of silicon of a silicone-modified acrylic resin in the ink is preferably form 100 to 400 ppm. When the amount is less than 100 ppm, it is hard to obtain an ink layer having good resistance to rubbing and tracing with a marker pen. In contrast, when the amount is greater than 400 ppm, the hydrophobicity increases, thereby deteriorating stability of the silicone-modified acrylic resin in the aqueous ink deteriorates.

The total content of the water dispersible resin and the pigment (colorant) in the ink is preferably from 5 to 40% by weight, and the weight ratio (R/P) of the water dispersible resin (R) and the pigment (P) is preferably from 0.5 to 4.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### 1. Preparation of Pretreatment Liquid

The following components were mixed and agitated well to prepare a pretreatment liquid.

| | |
|---|---|
| Lactic acid (agglomerating agent) | 15 g |
| N,N-diethylethanolamine (agglomerating agent) | 23.4 g |
| Calcium lactate (agglomerating agent) | 5 g |
| Glycerin (water soluble organic solvent) | 5 g |
| 1,3-Butanediol (water soluble organic solvent) | 5 g |
| Modified silicone oil (surfactant) | 1 g |
| (KF643 from Shin-Etsu Chemical Co., Ltd.) | |
| Benzisothiazolin-3-one (antibacterial agent) | 0.05 g |
| (PROXEL GXL from Avecia) | |
| 1,2,3-Benzotriazol (antirust) | 0.1 g |
| Pure water | 45.45 g |

### 2. Image Formation

Initially, the pretreatment liquid prepared above was applied on a surface of a coated paper (LUMI ART GLOSS from Stora Enso) using an applicator having such a structure as illustrated in FIG. 5. In this regard, the application amount of the pretreatment liquid was changed so as to be 0.10 mg/cm², 0.17 mg/cm², and 0.25 mg/cm².

Next, the coated paper bearing the pretreatment liquid thereon was manually set on an inkjet printer, IPSIO GX7000 from Ricoh Co., Ltd., to print a green solid image with a resolution of 600 dpi on the coated paper using a cyan ink and a yellow ink of the inkjet printer. In this regard, as described in Table 1 below, the time period between application of the pretreatment liquid and ejection of the inks was changed, and heating was or was not performed between application of the pretreatment liquid and ejection of the inks. Specifically, the time period between application of the pretreatment liquid and ejection of the inks was changed so as to be 3 seconds, 5 seconds and 10 seconds. The heating conditions were as follows:

Heater used: Drier (PRAJET PJ-206A from Ishizaki Electric Mfg. Co., Ltd.)

Distance between drier and recording medium: 10 cm

Heating time: 2 seconds

The printed images were visually observed to determine whether or not the images are even (i.e., whether or not the beading problem is caused). The results are shown in Table 1 below.

TABLE 1

| | | Application amount | |
|---|---|---|---|
| | Time period | of pretreatment liquid | Evenness of image |
| Heating | (sec) | (mg/cm²) | (Beading) |
| No | 3 | 0.10 | Even |
| | | 0.17 | Even |
| | | 0.25 | Even |
| | 5 | 0.10 | Uneven |
| | | 0.17 | Even |
| | | 0.25 | Even |
| | 10 | 0.10 | Uneven |
| | | 0.17 | Uneven |
| | | 0.25 | Even |
| Yes | 3 | 0.10 | Uneven |
| | | 0.17 | Uneven |
| | | 0.25 | Even |
| | 5 | 0.10 | Uneven |
| | | 0.17 | Uneven |
| | | 0.25 | Even |
| | 10 | 0.10 | Uneven |
| | | 0.17 | Uneven |
| | | 0.25 | Even |

It can be easily understood from Table 1 that the application amount of the pretreatment liquid for forming an even image without beading changes depending on the time period between application of the pretreatment liquid and ejection of the inks, and when the time period is relatively short, an even image can be formed even if the application amount of the pretreatment liquid is relatively small. In addition, it can be easily understood from Table 1 that the application amount of the pretreatment liquid for forming an even image changes depending on whether or not heating is performed, and when heating is to be performed, the application amount of the pretreatment liquid should be increased.

For example, when the time period between application of the pretreatment liquid and ejection of the inks is 3 seconds, an even image can be produced even when the application amount of the pretreatment liquid is 0.10 mg/cm². In contrast, when the time period is 5 seconds, an even image can be produced when the application amount of the pretreatment liquid is not less than 0.17 mg/cm². Therefore, when the pretreatment liquid is applied in an application amount of not less than 0.17 mg/cm² to produce an even image even in the case where the time period is 5 seconds, the application amount is too large for the case where the time period between application of the pretreatment liquid and ejection of the inks is 3 seconds. By using the image forming method according to an embodiment, in which the application amount is adjusted depending on the time period, even images can be produced without excessively consuming the pretreatment liquid.

In addition, when heating is performed between application of the pretreatment liquid and ejection of the ink, the application amount of the pretreatment liquid is preferably not less than 0.25 mg/cm². It can be understood form Table 1 that when heating is performed, the image quality hardly depends on the time period in the above-mentioned range of the time period. Namely, when heating is performed, the degree of dependence of the image quality (evenness) on the time period is lower than in the case where heating is not performed.

As described above, the image forming method according to an embodiment includes applying a pretreatment liquid, which has a function of preventing agglomeration of a colorant included in an ink, on a surface of a recording medium, and then ejecting droplets of the ink toward the surface of the recording medium coated with the pretreatment liquid to form an ink image on the surface, wherein the application amount of the pretreatment liquid is changed depending on the time period between application of the pretreatment liquid and ejection of the ink. Therefore, ink images having good evenness can be produced without excessively consuming the pretreatment liquid.

Additional modifications and variations of the present invention are possible in light of the above teachings. It is therefore to be understood that within the scope of the appended claims the invention may be practiced other than as specifically described herein.

What is claimed is:

1. An image forming method comprising:
applying a pretreatment liquid, which includes water, an organic solvent, and an agglomerating agent to agglomerate a colorant included in an ink, on a surface of a recording medium; and
ejecting the ink, which includes the colorant, and water, to form an image on the surface of the recording medium, on which the pretreatment liquid has been applied,
wherein the pretreatment liquid applying step includes:
changing an application amount of the pretreatment liquid depending on a time period between application of the pretreatment liquid and ejection of the ink.

2. The image forming method according to claim 1, wherein the application amount changing step is performed such that as the time period between application of the pretreatment liquid and ejection of the ink shortens, the application amount of the pretreatment liquid is decreased.

3. The image forming method according to claim 1, further comprising:
optionally heating the recording medium at a time between application of the pretreatment liquid and ejection of the ink, wherein the pretreatment liquid applying step further includes:
changing the application amount of the pretreatment liquid depending on whether or not the heating is performed.

4. The image forming method according to claim 1, wherein the pretreatment liquid applying step is performed using a pretreatment liquid applicator including an application amount measuring member to measure an amount of the pretreatment liquid, and a pretreatment liquid applying member to apply the measured pretreatment liquid on the recording medium.

5. The image forming method according to claim 4, wherein the application amount measuring member includes a roller to pick up the pretreatment liquid to transfer the pretreatment liquid to the pretreatment liquid applying member while measuring the pretreatment liquid, and wherein the application amount of the pretreatment liquid is changed by changing rotation speed of the roller.
